(19) United States
(12) Patent Application Publication
(10) Pub. No.: US 2025/0155660 A1
(43) Pub. Date: May 15, 2025

(54) MOUNTING ARRANGEMENT STRUCTURALLY CONFIGURED TO PROVIDE ENHANCED MOUNTING OF A FIBER OPTIC CASSETTE

(71) Applicant: BELDEN CANADA ULC, SAINT-LAURENT (CA)

(72) Inventors: Luc MILETTE, Montreal (QC) (CA); Cristian Leon BUENO, Verdun (QC) (CA); Charles-Olivier SKERLJ, Vaudreuil-sur-le-Lac (QC) (CA)

(73) Assignee: BELDEN CANADA ULC, SAINT-LAURENT (CA)

(21) Appl. No.: 18/946,856

(22) Filed: Nov. 13, 2024

Related U.S. Application Data
(60) Provisional application No. 63/548,326, filed on Nov. 13, 2023.

(51) Int. Cl. G02B 6/44

(52) U.S. Cl. CPC G02B 6/4452; G02B 6/4453

(57) ABSTRACT

A mounting arrangement may include a tray portion configured to couple with a fiber optic cassette and a rack portion structurally configured to receive the tray portion. The rack portion may include a holding portion structurally configured to hold the tray portion, the holding portion may include a receiving portion structurally configured to slidingly receive the tray portion, and the holding portion may include a locking portion configured to fix the tray portion at a predetermined position relative to the holding portion. The tray portion may include a surface portion that includes an attachment portion structurally configured to couple with a fiber optic cassette such that a fiber optic port portion of the fiber optic cassette faces in a direction of a side surface portion of the tray portion that is perpendicular to the surface portion. The holding portion may be configured to alternatively receive the tray portion in a first orientation wherein the side surface portion of the tray portion faces in a first direction toward the holding portion and in a second orientation wherein the side surface portion of the tray portion faces in a second direction, opposite to the first direction, toward the holding portion so as to enhance mounting of a fiber optic cassette.

### CROSS-REFERENCE TO RELATED APPLICATION

This application claims the benefit of U.S. Provisional Application No. 63/548,326, filed Nov. 13, 2023, pending, the disclosure of which is hereby incorporated by reference herein in its entirety.

### TECHNICAL FIELD

The present disclosure is directed to a network component mounting system and, more particularly, to a rack assembly for multiple network components with individual reversibility.

### BACKGROUND

Increased use wired and wireless signal pathway by commercial and residential consumers has heightened the number of signal network components working in conjunction. While physical mounting of network components has been facilitated, in the past, with static equipment that correspond with designated component orientations and positions. Such static component configurations can provide practical functionality for some equipment and network connectivity, but can be limited in mounting options that reduce the ability to utilize equipment in manners that optimize the capabilities of some network equipment.

The lack of physical mounting options for some network equipment has emphasized innovation in mounting systems that provide diverse equipment positioning and orientations. Accordingly, various embodiments are directed to network equipment mounting systems that provide a variety of equipment configurations.

It may be desirable to provide a mounting arrangement that is structurally configured to provide enhanced mounting of a fiber optic cassette. It may be desirable to provide a mounting arrangement that is structurally configured to provide enhanced access to a mounted fiber optic cassette. It may be desirable to provide a mounting arrangement that is structurally configured to provide enhanced fiber management.

### SUMMARY

In accordance with various aspects of the disclosure, a mounting arrangement may include a tray portion configured to couple with a fiber optic cassette and a rack portion structurally configured to receive the tray portion. The rack portion may include a first rack portion and a second rack portion, the first rack portion may be identical to the second rack portion, and the rack portion may include a holding portion structurally configured to hold the tray portion. The holding portion may include a receiving portion structurally configured to slidingly receive the tray portion, the holding portion may include a first holding portion and a second holding portion that are spaced apart from one another, and the first rack portion may include the first holding portion, and the second rack portion may include the second holding portion. The receiving portion may include a first receiving portion and a second receiving portion, the first holding portion may include the first receiving portion, and the second holding portion may include the second receiving portion. The holding portion may include a locking portion configured to fix the tray portion at a predetermined position relative to the holding portion, the locking portion may include a first locking portion and a second locking portion, the first holding portion may include the first locking portion, and the second holding portion may include the second locking portion. The tray portion may include a surface portion that includes an attachment portion structurally configured to couple with a fiber optic cassette such that a fiber optic port portion of the fiber optic cassette faces in a direction of a side surface portion of the tray portion that is perpendicular to the surface portion. The holding portion may be configured to alternatively receive the tray portion in a first orientation wherein the side surface portion of the tray portion faces in a direction of the first holding portion and in a second orientation wherein the side surface portion of the tray portion faces in a direction of the second holding portion so as to enhance mounting of a fiber optic cassette.

In some embodiments of the aforementioned mounting arrangement, the attachment portion may be configured to face in a first direction that is perpendicular to the side surface portion of the tray portion in the first orientation and the second orientation, the holding portion may be configured to alternatively receive the tray portion in a third orientation wherein the side surface portion of the tray portion faces in a direction of the first holding portion, and the attachment portion faces in a second direction opposite to the first direction, and the holding portion may be configured to alternatively receive the tray portion in a fourth orientation wherein the side surface portion of the tray portion faces in a direction of the second holding portion, and the attachment portion faces in a second direction opposite to the first direction.

In some embodiments of the aforementioned mounting arrangements, the locking portion may include an engagement portion, and the tray portion may include a retaining portion structurally configured to receive the engagement portion so as to fix the tray portion at the predetermined position relative to the holding portion.

In some embodiments of the aforementioned mounting arrangements, the engagement portion may be structurally configured to be biased to a first configuration so as to be received in the retaining portion and fix the tray portion at the predetermined position relative to the holding portion.

In some embodiments of the aforementioned mounting arrangements, the engagement portion may be structurally configured to be urged out of the retaining portion by the tray portion in response to a pulling force applied to the tray portion so as to release the tray portion from the predetermined position relative to the holding portion and permit the tray portion to slide relative to the holding portion.

In some embodiments of the aforementioned mounting arrangements, the holding portion may include a plurality of holding portions, the tray portion may include a plurality of tray portions, and the plurality of holding portions may be arranged so as to receive the plurality of tray portions in a stacked configuration.

In accordance with various aspects of the disclosure, a mounting arrangement may include a tray portion configured to couple with a fiber optic cassette and a rack portion structurally configured to receive the tray portion. The rack portion may include a holding portion structurally configured to hold the tray portion, the holding portion may include a first holding portion and a second holding portion that are spaced apart from one another, the holding portion may include a receiving portion structurally configured to slidingly receive the tray portion, and the holding portion may include a locking portion configured to fix the tray portion at a predetermined position relative to the holding portion. The tray portion may include a surface portion that includes an attachment portion structurally configured to couple with a fiber optic cassette such that a fiber optic port portion of the fiber optic cassette faces in a direction of a side surface portion of the tray portion that is perpendicular to the surface portion. The holding portion may be configured to alternatively receive the tray portion in a first orientation wherein the side surface portion of the tray portion faces in a direction of the first holding portion and in a second orientation wherein the side surface portion of the tray portion faces in a direction of the second holding portion so as to enhance mounting of a fiber optic cassette.

In some embodiments of the aforementioned mounting arrangements, the attachment portion may be configured to face in a first direction that is perpendicular to the side surface portion of the tray portion in the first orientation and the second orientation, the holding portion may be configured to alternatively receive the tray portion in a third orientation wherein the side surface portion of the tray portion faces in a direction of the first holding portion, and the attachment portion faces in a second direction opposite to the first direction, and the holding portion may be configured to alternatively receive the tray portion in a fourth orientation wherein the side surface portion of the tray portion faces in a direction of the second holding portion, and the attachment portion faces in a second direction opposite to the first direction.

In some embodiments of the aforementioned mounting arrangements, the locking portion may include an engagement portion, and the tray portion may include a retaining portion structurally configured to receive the engagement portion so as to fix the tray portion at the predetermined position relative to the holding portion.

In some embodiments of the aforementioned mounting arrangements, the engagement portion may be structurally configured to be biased to a first configuration so as to be received in the retaining portion and fix the tray portion at the predetermined position relative to the holding portion.

In some embodiments of the aforementioned mounting arrangements, the engagement portion may be structurally configured to be urged out of the retaining portion by the tray portion in response to a pulling force applied to the tray portion so as to release the tray portion from the predetermined position relative to the holding portion and permit the tray portion to slide relative to the holding portion.

In some embodiments of the aforementioned mounting arrangements, the holding portion may include a plurality of holding portions, the tray portion may include a plurality of tray portions, and the plurality of holding portions may be arranged so as to receive the plurality of tray portions in a stacked configuration.

In some embodiments of the aforementioned mounting arrangements, the rack portion may include a first rack portion and a second rack portion, and the first rack portion includes the first holding portion, and the second rack portion includes the second holding portion. In some aspects, the first rack portion may be identical to the second rack portion.

In some embodiments of the aforementioned mounting arrangements, the receiving portion may include a first receiving portion and a second receiving portion, and the first holding portion may include the first receiving portion, and the second holding portion includes the second receiving portion.

In some embodiments of the aforementioned mounting arrangements, the locking portion may include a first locking portion and a second locking portion, the first holding portion may include the first locking portion, and the second holding portion may include the second locking portion.

In accordance with various aspects of the disclosure, a mounting arrangement may include a tray portion configured to couple with a fiber optic cassette and a rack portion structurally configured to receive the tray portion. The rack portion may include a holding portion structurally configured to hold the tray portion, the holding portion may include a receiving portion structurally configured to slidingly receive the tray portion, and the holding portion may include a locking portion configured to fix the tray portion at a predetermined position relative to the holding portion. The tray portion may include a surface portion that includes an attachment portion structurally configured to couple with a fiber optic cassette such that a fiber optic port portion of the fiber optic cassette faces in a direction of a side surface portion of the tray portion that is perpendicular to the surface portion. The holding portion may be configured to alternatively receive the tray portion in a first orientation wherein the side surface portion of the tray portion faces in a first direction toward the holding portion and in a second orientation wherein the side surface portion of the tray portion faces in a second direction, opposite to the first direction, toward the holding portion so as to enhance mounting of a fiber optic cassette.

In some embodiments of the aforementioned mounting arrangements, the attachment portion may be configured to face in a third direction that is perpendicular to the side surface portion of the tray portion in the first orientation and the second orientation, the holding portion may be configured to alternatively receive the tray portion in a third orientation wherein the side surface portion of the tray portion faces in the first direction, and the attachment portion faces in a fourth direction opposite to the third direction, and the holding portion may be configured to alternatively receive the tray portion in a fourth orientation wherein the side surface portion of the tray portion faces in the second direction, and the attachment portion faces in a fourth direction opposite to the first direction.

In some embodiments of the aforementioned mounting arrangements, the locking portion may include an engagement portion, and the tray portion may include a retaining portion structurally configured to receive the engagement portion so as to fix the tray portion at the predetermined position relative to the holding portion.

In some embodiments of the aforementioned mounting arrangements, the engagement portion may be structurally configured to be biased to a first configuration so as to be received in the retaining portion and fix the tray portion at the predetermined position relative to the holding portion.

In some embodiments of the aforementioned mounting arrangements, the engagement portion may be structurally configured to be urged out of the retaining portion by the tray portion in response to a pulling force applied to the tray portion so as to release the tray portion from the predetermined position relative to the holding portion and permit the tray portion to slide relative to the holding portion.

In some embodiments of the aforementioned mounting arrangements, the holding portion may include a plurality of holding portions, the tray portion may include a plurality of tray portions, and the plurality of holding portions may be arranged so as to receive the plurality of tray portions in a stacked configuration.

In some embodiments of the aforementioned mounting arrangements, the holding portion may include a first holding portion and a second holding portion that are spaced apart from one another.

In some embodiments of the aforementioned mounting arrangements, the holding portion may be configured to alternatively receive the tray portion in the first orientation wherein the side surface portion of the tray portion faces in a direction of the first holding portion and in the second orientation wherein the side surface portion of the tray portion faces in a direction of the second holding portion so as to enhance mounting of a fiber optic cassette.

In some embodiments of the aforementioned mounting arrangements, the rack portion may include a first rack portion and a second rack portion, and the first rack portion may include the first holding portion, and the second rack portion includes the second holding portion. In some aspects, the first rack portion may be identical to the second rack portion.

In some embodiments of the aforementioned mounting arrangements, the receiving portion may include a first receiving portion and a second receiving portion, and the first holding portion may include the first receiving portion, and the second holding portion includes the second receiving portion.

In some embodiments of the aforementioned mounting arrangements, the locking portion may include a first locking portion and a second locking portion, the first holding portion may include the first locking portion, and the second holding portion may include the second locking portion.

### BRIEF DESCRIPTION OF THE DRAWINGS

Further advantages and features of the present disclosure will become apparent from the following description and the accompanying drawings, to which reference is made.

FIG. 1 is a line representation of portions of a network environment in which assorted embodiments can be practiced.

FIG. 2 is a line representation of portions of an example network assembly that can be employed in the environment of FIG. 1.

FIG. 3 is a perspective view of portions of a network component mounting system that can be utilized in the network assembly of FIG. 2.

FIG. 4 is a perspective view of an exemplary rack portion of a network component mounting system in accordance with various aspects of the disclosure.

FIG. 5 is perspective view of an exemplary rack including two of the rack portions shown in FIG. 4.

FIG. 6 is a side view of the exemplary rack portion shown in FIG. 4.

FIG. 7 is a perspective view of the exemplary rack shown in FIG. 5 with exemplary tray portions received by the rack.

FIG. 8 is a side view of an exemplary rack and exemplary tray portions in accordance with various embodiments of this disclosure.

FIG. 9 is a perspective view of portions of an exemplary rack and exemplary tray portions in accordance with various embodiments of this disclosure.

FIG. 10 is a perspective view of an exemplary tray portion in accordance with various embodiments of this disclosure.

FIG. 11 is a front view of the exemplary tray portion shown in FIG. 10.

FIG. 12 is a perspective view of the view of the exemplary rack and exemplary tray portions shown in FIG. 8.

FIG. 13 is a perspective view of portions of a network component mounting system employed in accordance with various embodiments of this disclosure.

### DETAILED DESCRIPTION

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

Through the use of reversible trays and soft lock features in rails that allow sliding tray articulation, one or more network components can be securely mounted in a variety of orientations, which allow for customized connectivity and efficient cable management. The ability to orient a network component in a variety of different orientations corresponds with increased cabling accuracy and accessibility that increases the efficiency of installation and alterations over time. In contrast, a static network component mounting system with few component orientation options can limit the space and cooling configurations of a network in order to provide cable connectivity and organization.

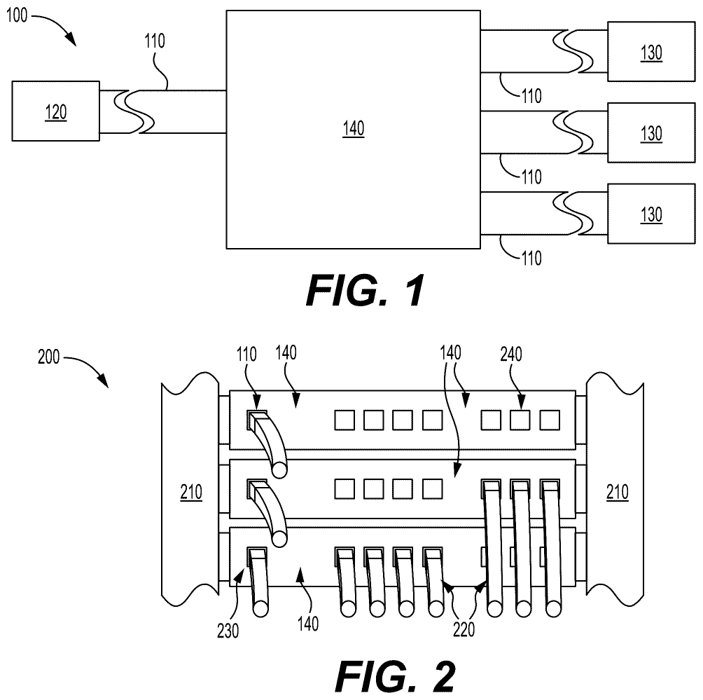

Accordingly, various embodiments are directed to a mounting system for one or more network components that provide options for mounting orientations and cable connectivity. FIG. 1 generally illustrates a line representation of portions of a network environment 100 in which assorted embodiments of a mounting system can be practiced. Any number, and type, of cable 110, can be used to connect at least one signal source 120 with at least one signal destination 130. It is noted that a cable 110 can have any number of signal conductors that are electrically isolated, shielded, and/or protected by at least one dielectric material.

While a single cable 110 can provide a signal pathway from a source 120 to a destination 130, such configuration may not be practical, or possible, in some installation sites and/or signal configurations. For instance, multiple signal conductors from a single cable 110 may be separated to connect to different destinations 130. As such, one or more interconnects 140, such as a switch, server, amplifier, filter, interface, adapter, connector, or electronic device, can provide cable 110 connectivity that provides options and optimization of signal transmission from source(s) 120 to destination(s) 130. In other words, the use of one or more interconnects 140 allows separate cables 110 to be effectively utilized to form at least one continuous signal pathway between source(s) 120 and destination(s) 130.

Although an interconnect 140 can be any assembly, device, or interface that connects separate cables 110 to form at least one continuous signal pathway from a source 120 to a destination 130, the physical mounting of an interconnect 140 can provide difficulties and challenges for installation, operation, and alteration. FIG. 2 illustrates a line representation of portions of a cable assembly 200 in which multiple interconnects 140 are physically mounted in accordance with various embodiments of the present disclosure.

The cable assembly 200 has a rigid rack 210 that provides multiple mounting slots 212 that respectively receive a cable interconnect 140. It is noted that while the interconnect 140 shown in FIG. 2 can be characterized as a switch, server, or cassette that translates input cabling 110 into multiple output cabling 220, such interconnect 140 configuration is not required as interconnects 140 of other types, sizes, connectivity, and capabilities can be employed, without limitation.

As shown in FIG. 2, the physical position and orientation of the respective interconnects 140 are uniform throughout the rack 210, which arranges the various input ports 230 and output ports 240 in a single plane facing away from the rack 210. However, such configuration is not required or limiting as one or more of the interconnects 140 can be orientated differently from other interconnects 140 of the rack 210 so that cables 110/220, and ports 230/240 are directed towards the rack 210, which would be a rotation of 90 degrees compared to the embodiment shown in FIG. 2. The ability to orient one or more interconnects 140 differently than other interconnects of a rack 210 can provide customization that can accommodate different cabling and/or rack housing environments.

The arrangement of the assorted ports 230/240 allows easy access to the respective interconnects 140 individually, but can pose efficiency, organization, management, and alteration difficulties over time when the rack 210 has multiple interconnects 140 occupied with various cables 110/220. For instance, input cables 110 can be difficult to discern from output cables 220 just as cables 110/220 connecting to one interconnect 140 can be difficult to discern from cables 110/220 connecting to other interconnects 140. In addition to organizational cabling issues, the rack 210 configuration shown in FIG. 2 provides little cooling and cable density options as the mounting hardware that has been conventionally employed is limited.

With these issues in mind, various embodiments are directed to a mounting system for network components and cabling that allows for efficient cooling and cable management with relatively high physical density within a mounting rack 210. The ability to efficiently articulate and access various interconnects 140, in accordance with various embodiments, further enhances the capabilities of a mounting system to optimize the concurrent presence and operation of multiple interconnects 140 within a single rack 210.

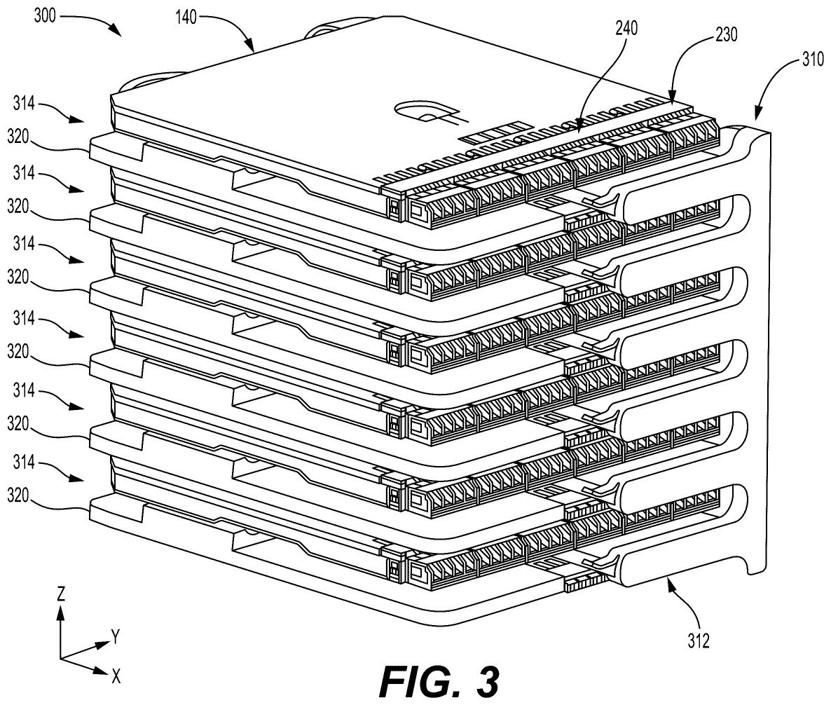

FIGS. 3-13 respectively display various aspects of a mounting system 300 configured and employed in accordance with embodiments of this disclosure. The perspective view of FIG. 3 illustrates how a mounting system 300 can provide secure physical placement of several separate cable interconnects 140, for example, fiber optic cassettes or modules, within a component rack or rack portion 310, for example, a cassette rack. The rack 310 may be arranged with any number of holding portions 312, for example, rails, that respectively define a receiving portion 314, for example, a slot or channel, where a tray portion 320 can be slidingly received to allow access to an interconnect 140, such as, for example, a fiber optic cassette.

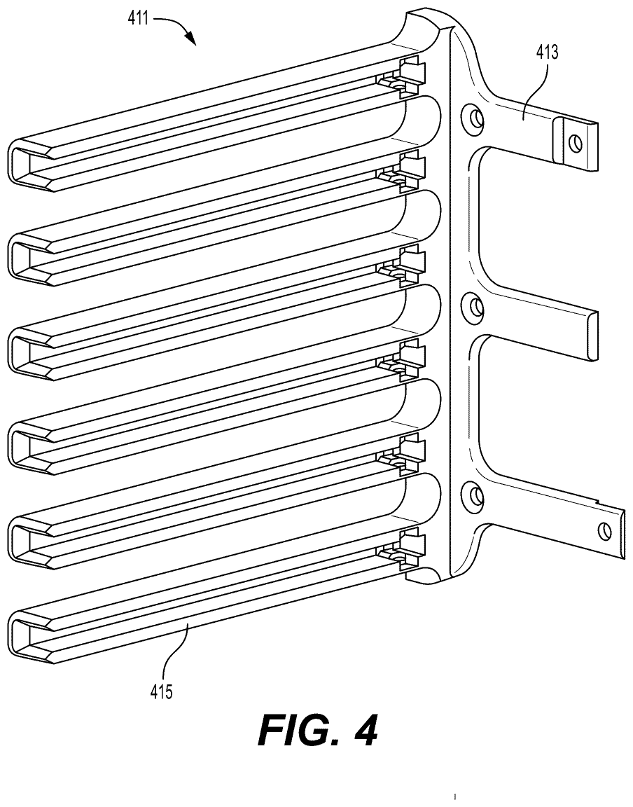

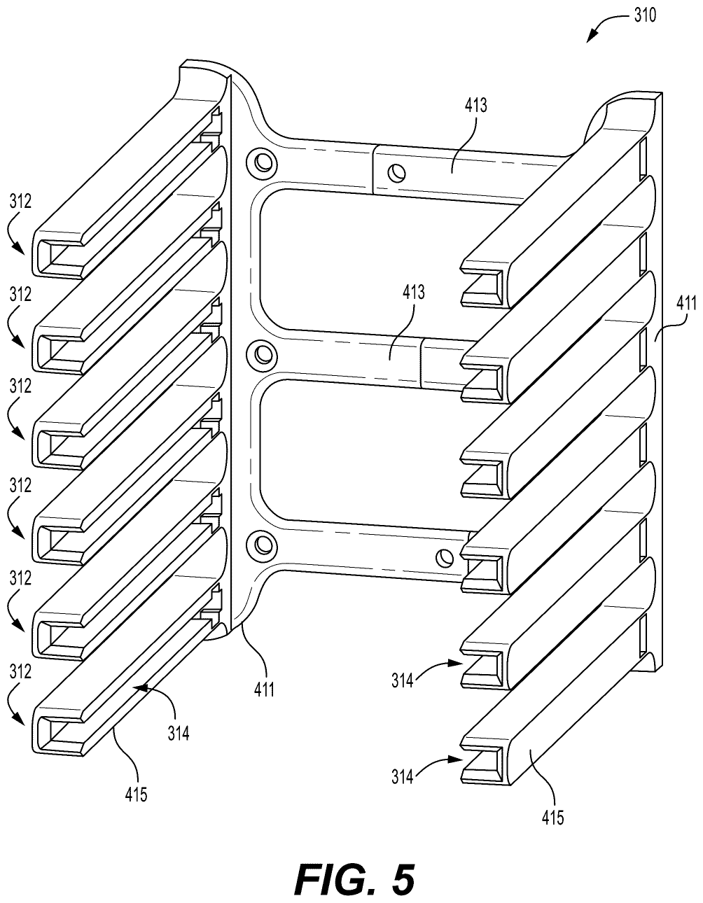

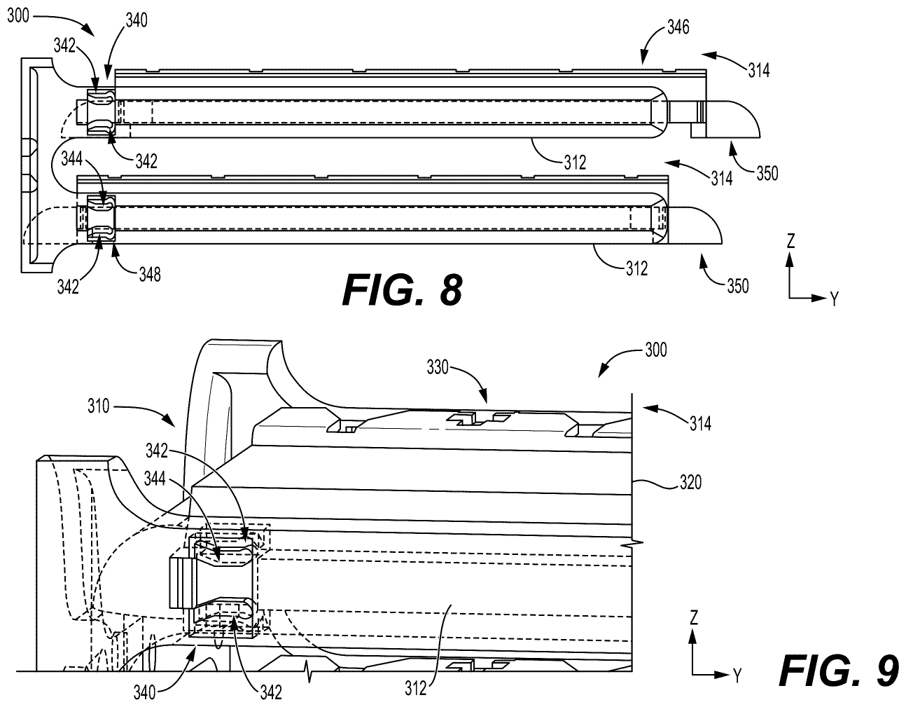

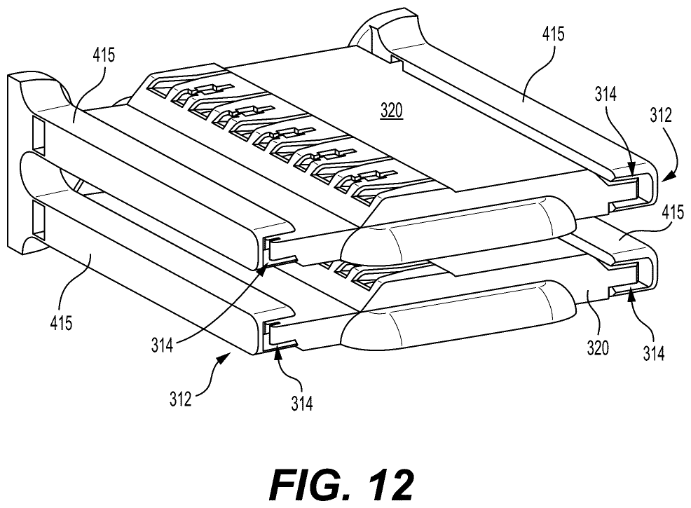

Referring to FIGS. 4 and 5, in some aspects, the rack 310 may include two identical rack portions 411 that are configured to be coupled to one another by rotating one of the rack portions 411 by 180 degrees. The rack portions 411 may be secured to one another and/or to a mounting surface to form the rack 310. In some embodiments, the rack 310 may comprise six holding portions 312, as shown, or may comprise any other number of holding portions. For example, as shown in FIGS. 8 and 12, a rack may include two holding portions 312.

Each rack portion 411 may include a mounting portion 413 and a rail portion 415. As would be understood by persons skilled in the art, the mounting portion 413 of one rack portion 411 is configured to be coupled with mounting portion 413 of a second rack portion 411, after the second rack portion is rotated 180 degrees, to form the rack 310.

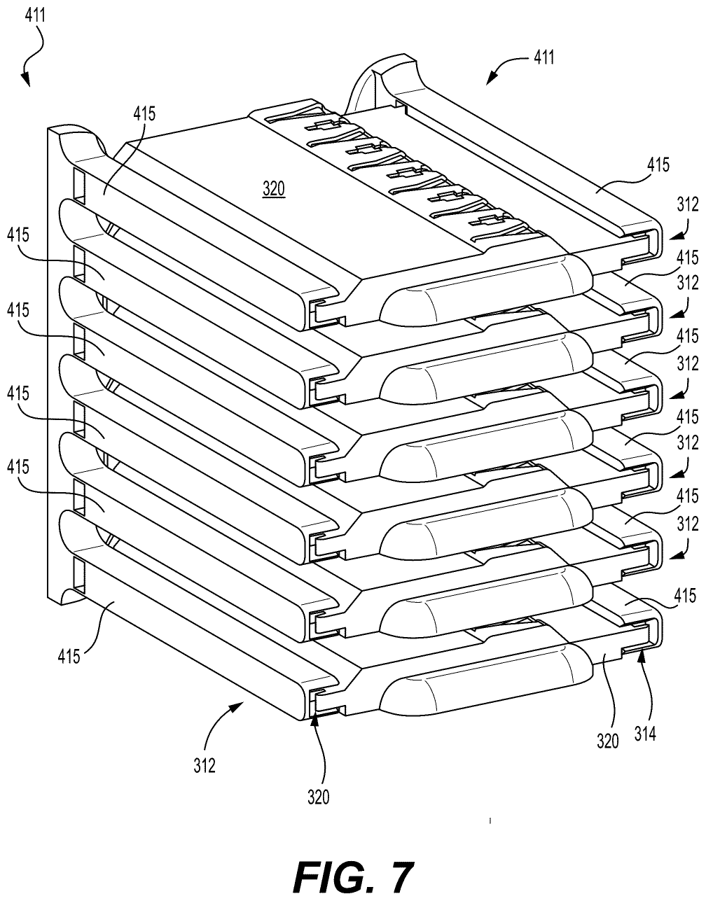

The holding portion 312 may be defined by opposing rail portions 415 of two rack portions 411. For example, each rail portion 415 may include the receiving portion 314 arranged so that the two opposed receiving portion 314 are configured to receive the tray portion 320, as shown in FIG. 7.

With each tray 320 fully inserted into the rack 310, as shown in FIG. 3, some interconnects 140 may be positioned atop one tray 320 and below another tray, which optimizes the physical density of cable 110 connections in the mounting system 300. It is noted that each interconnect 140 may be attached to a tray 320 and oriented so that cable ports 230/240 face the holding portions 312, which contrasts the front-facing interconnect ports shown in FIG. 2.

By orienting the interconnect ports 230/240 towards the holding portions 312, which can be characterized as the lateral sides of the rack 310, cables 110/220 connecting to stacked interconnects 140 can be separated by the holding portions 312 instead of collectively hanging together in front of the rack 310. Such separation can aid with installation, access, and alteration of the assorted connections of the mounting system 300 by efficiently correlating cables 110/220 to interconnects 140. Likewise, lateral cable 110/220 orientation allows for efficient identification of input cables 110 and output cables 220 when the ports 230/240 are positioned on opposite, lateral sides of the interconnect 140.

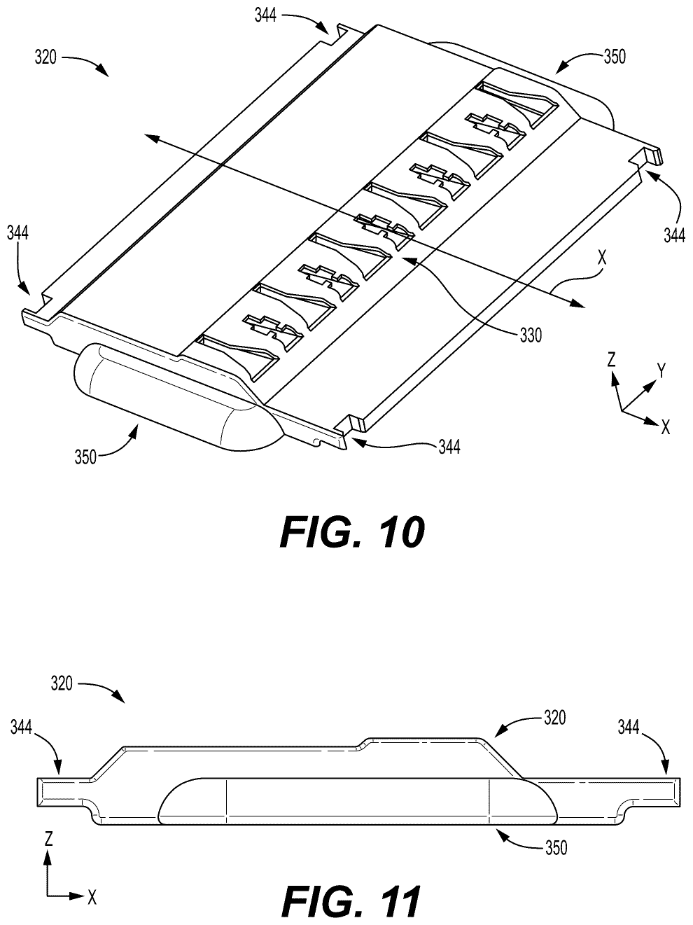

In accordance with various embodiments, each tray portion 320 may have a symmetrical overall shape about the transverse axis (X axis) of the rack 310 and holding portion 312 to allow for tray reversibility, as illustrated in FIG. 10. That is, the shape, size, and features of a tray portion 320 are symmetrical from front to back, across a median transverse tray axis. Such tray symmetry allows a tray portion 320 to engage a holding portion 312 to occupy a receiving portion 314 with opposite sides of the tray portion 320. In other words, the tray portion 320 configuration provides proper engagement with the holding portions 312 with opposite sides of the tray portion 320.

The ability to properly engage a pair of holding portions 312 and occupy a receiving portion 314 with a tray portion 320 from opposite sides of the tray portion 320 allows for more efficient and accurate installation than a tray portion 320 having a single orientation that properly engages the holding portions 312. The symmetric configuration of the tray portion 320 is complemented by an attachment portion 330, for example, a network component attachment feature, as shown in FIG. 10, that allows one or more network components, such as an interconnect 140, to be securely placed in the rack 310 with selected port position and orientation.

As a result, a technician can transition cable ports 230/240 of an interconnect 140 from between lateral sides of the rack 310, towards a single holding 312, simply by rotating the tray portion 320 180 degrees. It is noted that the rotation of the tray portion 320, instead of detaching and reattaching the interconnect 140 from the tray portion 320, provides increased speed and reliability along with the ability to efficiently adapt a rack 310 to different interconnect 140 and port 230/240 configurations that can customize, and optimize, cable 110/220 organization, management, and alteration.

A tray portion 320, in some embodiments, may be statically attached within a receiving portion 314 with one or more fasteners. Other embodiments of a receiving portion 314 provide a sliding tray portion 320 engagement along the longitudinal tray axis (Y axis) where the tray portion 320 can move while being retained within the holding portion 312, which allows for articulation of the tray 320 and attached interconnect 140 without having to support the weight of the collective tray/interconnect. Various embodiments of a rack 310 configure a receiving portion 314 with one or more lock portions 340 that prevent movement of a tray portion 320 in the receiving portion 314 until a sufficient amount of force is applied.

The mounting system 300 may be configured with several vertically stacked, along the Z axis, receiving portions 314 respectively occupied by tray portions 320 and network components. It is noted that the holding portions 312 may be arranged to provide any number of receiving portions 314 that are individually configurable. That is, the mounting system 300 may be modular and have holding portion 312 added or removed to provide different numbers of receiving portions 314 and different network component capacity. It is contemplated that receiving portions 314 may be added to the mounting system 300 that are unused, which may contribute to greater passive, or active, cooling performance over time during operation of one or more network components.

FIG. 8 illustrates portions of the mounting system 300 in which the respective tray portions 320 are present without attached network components. However, the tray portion 320 movement and behavior exhibited in FIG. 4 can be practiced with a network component physically connected to each tray portion 320 via the attachment portion 330 of each tray portion 320. The interaction of the tray portion 320 with the holding portions 312 may include one or more bearings, but such configuration is not required as the tray portion 320 may slide within, or atop, the holding portions 312 without a mechanism for facilitating movement.

As shown by the cutout of the respective holding portions 312, each tray portion 320 may be configured to engage a lock portion 340 that provides secure retention of the tray portion 320 until force above a predetermined threshold is applied. That is, portions of the tray portion 320 can be configured to physically engage portions of the holding portion 312 that collectively provide increased physical retention of the tray portion 320 compared to rail/tray configurations that do not utilize a lock portion 340. The arrangement of the lock portion 340 can allow for simple and efficient retention, or freeing, of a tray portion 320 relative to a holding portion 312. For instance, the lock portion 340 can be configured to allow one-handed engagement and tray portion retention from a technician prior to one-handed separation of the tray portion 320 from the lock portion 340. In other words, the lock portion 340 and tray portion 320 can be collectively configured so that a relatively low force threshold is needed to secure the tray portion 320 within the holding portion 312 or free the tray portion 320 from the lock portion 340 so that tray portion 320 movement is freely available.

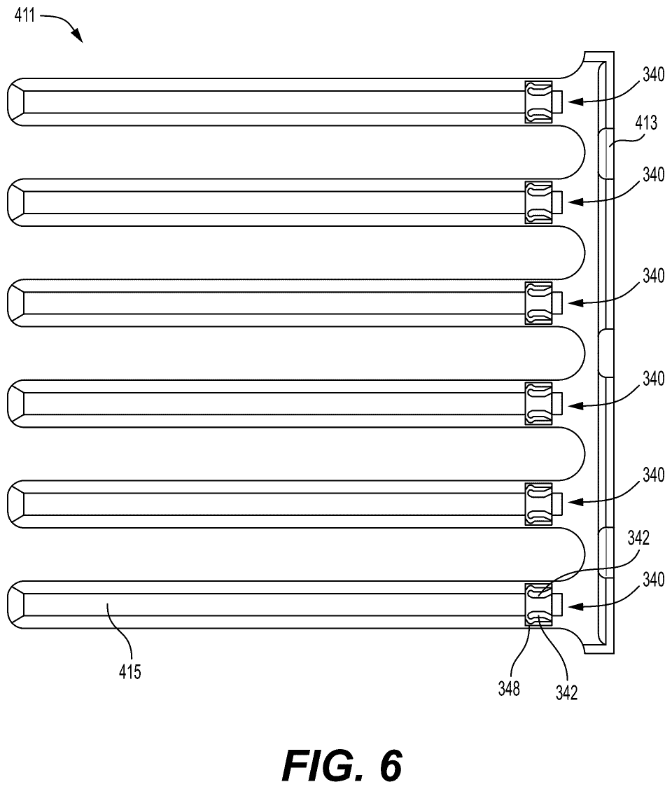

Although the configuration of the lock portion 340 shown in FIGS. 6 and 8 is not required or limiting, it conforms with an embodiment where an engagement portion 342, for example, a pair of tabs, positioned within a holding portion 312 flexibly engage a retaining portion 344 of the tray portion 320 to provide heightened physical retention of the tray portion 320. In operation, the tabs 342 respond to movement of the retaining portion 344 of the tray portion 320 by initially expanding until the retaining portion 344 reaches a predetermined depth within the holding portion 312 where the engagement portion 342 retracts to a default position that concurrently contacts opposite sides of the retaining portion 344 and provides enhanced physical retention. It is noted that upon application of force above the flexible threshold of the engagement portion 342, the retaining portion 344 will induce the engagement portion 342 to move and release the tray portion 320 for free movement along the holding portion 312.

Various embodiments may position a lock portion 340 near or substantially at the maximum depth of the holding portion 312, along the Y axis, to provide enhanced physical retention when the tray portion 320 is fully installed within the receiving portion 314 and holding portion 312. However, other embodiments may position other lock portions 340 at different locations along the holding portion 312 to provide increased physical retention at desired tray positions relative to the holding portion 312. For instance, a lock portion may be positioned proximal the entrance 346 of the receiving portion 314 to retain the tray portion 320 while a majority of the tray portion 320 is out of the holding portion 312, which increases visual and physical access to portions of the tray portion 320 and the attached network component.

As such, a technician could selectively retain the tray holding portion 320 in multiple different positions relative to the holding portion 312 by providing variable force that pushes a lock portion 344 through a first rail lock portion to a second rail lock portion positioned at a greater tray depth within the receiving portion 314 and holding portion 312. Various embodiments of a mounting system 300 arrange a window cutout portion 348 of the holding portion 312, as shown, that allows visual access to the lock portion 340 and provides an ability to manually remove debris and/or apply force to release the lock portion 344. It is contemplated that a holding portion 312 can employ tray locks 340 so as to couple on a single side of the tray portion 320 or on opposite sides of the tray portion 320. The flexibility to position any number of lock portions 340 in any location along one or more holding portions 312 allows for tray movement customization that can be catered to the weight, shape, cabling, and/or port configuration of a network component attached to the tray holding portion 320.

The separated, but physically joined by the rack 310, configuration of the respective receiving portions 314 allows a single tray portion 320 and connected network component to be moved while other tray portions 320 remain physically secured by lock portions 340 of the respective holding portions 312. In practice, the ability to individually select a tray portion 320, or multiple tray portions 320 at a time, while remaining tray portions 320 are secure fully within their respective receiving portions 314 allows a technician to efficiently access and alter various characteristics of a network component, such as cabling, activation, or operational switches. The individual selection of tray portions 320 further allows a technician to reorganize the position and/or orientation of a network component by reversing the position of the tray portion 320 between the holding portions 312. As a result, the mounting system 300 can provide diverse configurations that can be catered to a variety of different operational environments and network connectivity needs.

As illustrated with the exposed line representation of portions of the mounting system 300 in FIG. 9, a lock portion 340 can include an engagement portion 342, for example, flexible fingers or tabs, respectively shaped to respond to contact with the tray portion 320 and subsequently occupy the retaining portion 344 of the tray to apply consistent retention force on the tray portion 320. Consequently when the engagement portion 342 occupies the retaining portion 344, the tray portion 320 will not move relative to the holding portion 312 until force above a material flexibility threshold of the engagement portion 342 is applied to cause the engagement portion 342 to be urged from the retaining portion 344 and release free movement of the tray portion 320 in the receiving portion 314. It is noted that the configuration of the engagement portion 342 and retaining portion 344 is not limited to a particular shape, size, and arrangement and can be any mechanism that retains the tray portion 320 during applied forces below a predetermined threshold and releases the tray portion 320 in response to applied force above the predetermined threshold.

The relatively simplistic engagement of the engagement portion 342 to the retaining portion 344 allows for efficient tray portion 320 manipulation, such as sliding, locking, and releasing. Some embodiments configure the tray portion 320 and lock portion 340 to allow one-handed operation to secure, move, or release a tray portion 320 while providing reliable physical support for the tray portion 320 and attached network component. The ability to customize the material, size, and operation of one or more lock portion 340 can allow the tray portion 320 manipulation that is catered to a desired strength and operation profile.

FIG. 10 illustrates a perspective view of portions of a tray portion 320 that can be employed in a mounting system rack in accordance with assorted embodiments. The tray portion 320 has a retaining portion 344 approximately at each corner, which allows for multiple different locking positions relative to the holding portion 312 and receiving portion 314. The respective retaining portions 344 can be matching, or dissimilar, features that physically engage the engagement portion 342 to provide enhanced retention. It is contemplated that a retaining portion 344 may be configured as a notch or cutout that has a shape and size that can engage, and be retained by, engagement portions 342. The retaining portion 344, in other embodiments, can include one or more aspects that move to engage engagement portions 342, such as a mechanical, pneumatic, or hydraulic articulating aspect.

The configuration of the retaining portion 344 can correspond with accurate and reliable sliding engagement with holding portion 312 while providing the ability to secure the tray portion 320 in place. The engagement of the retaining portion 344 with the engagement portion 342, as shown in FIGS. 8 and 9, can be arranged to allow a range of tray movement, such as, for example, one inch of travel, while being secured by a lock portion 340. Such movement allowance while the retaining portion 344 engages the engagement portion 342 can allow greater access and/or control of the network component contacting one or more aspects of the attachment portion 330. However, other embodiments of the retaining portion 344 may secure the tray portion 320 with minimal play, such as less than one centimeter or one millimeter, when engaged with the engagement portion 342.

The tray 320 may have a pair of handle portions or handles 350 respectively positioned on opposite transverse sides, along the Y axis. Such handle positioning allows for efficient tray 320 reversibility as a convenient tray engagement handle 350 is present between holding portions 312 regardless of the orientation of the tray 320. While a single handle 350 may be employed or handles 350 could be constructed with dissimilar sizes, shapes, or positions, various embodiments arrange the tray 320 as a symmetrical structure about the longitudinal axis (Y axis), which includes the retaining portion 344 and handles 350.

It is noted that the symmetric arrangement of the tray portion 320 does not, necessarily, extend to the attachment portion 330. By making the outer periphery of the tray 320 symmetric, the tray 320 can be reversed within a receiving portion 314 without altering the tray 320 or holding portion 312. The ability to configure the attachment portion 330 without concern for longitudinal symmetry allows for a diverse variety of physical aspects, such as grooves, ridges, protrusions, apertures, and slots, to physically connect to one or more network components.

In some embodiments, portions of the attachment portion 330 are deliberately not symmetrical about the tray's longitudinal axis to allow different network component positions depending on the orientation of the tray 320 within a receiving portion 314. That is, portions of the attachment portion 330 can be offset from, and non-symmetrical about, the tray's longitudinal axis (Y axis) so that connected network component(s) have a different position in a receiving portion 314 and between holding portions 312 depending on the orientation of the tray 320. Accordingly, the reversible trays 320 of a rack 310 can provide staggered positioning of network components simply by alternating the orientation of vertically (Z axis) adjacent trays 320 within the respective receiving portions 314.

A front view of a tray 320 is illustrated in FIG. 11 and conveys how the attachment portion 330 can have a varying topography while rising above the plane of the retaining portion 344. Such elevation of the attachment portion 330, along with any connected network components, can provide enhanced visual and physical access to aspects of a network component, such as lights, ports, buttons, or switches, In addition, the rise of the attachment portion 330 relative to the retaining portion 344 can increase cooling capabilities, particularly in a vertically stacked mounting system where heat from operating network components rise over time.

Various embodiments of a mounting system 300 utilize a single, unitary tray 320 construction, which reduces cost and weight while increasing interchangeability and fabrication accuracy. For instance, a tray 320 can be cast, printed, forged, formed, or molded in relatively large quantities with high reliability and dimensional accuracy to allow efficient installation and alteration of a network mounting rack 310. It is contemplated that a tray 320 is constructed of a single material, such as a polymer, but such arrangement is not required as a tray 320 may be a combination of one or more materials, such as metal and plastic, that customize the strength, cooling performance, and weight of a tray 320.

The ability to provide multiple different network component attachment capabilities in a tray 320 further optimizes the interchangeability and modular aspects of a mounting system 300. Yet, some embodiments of a mounting system 300 employ trays 320 with differing configurations, such as lock portions 340, attachment portions 330, or handle portions 350, to customize the access, cooling, and/or cable management of a mounting system 300 concurrently employing multiple separate network components respectively mounted on separate trays 320 each in sliding communication with separate pairs of holding portions 312 that define separate receiving portions 314.

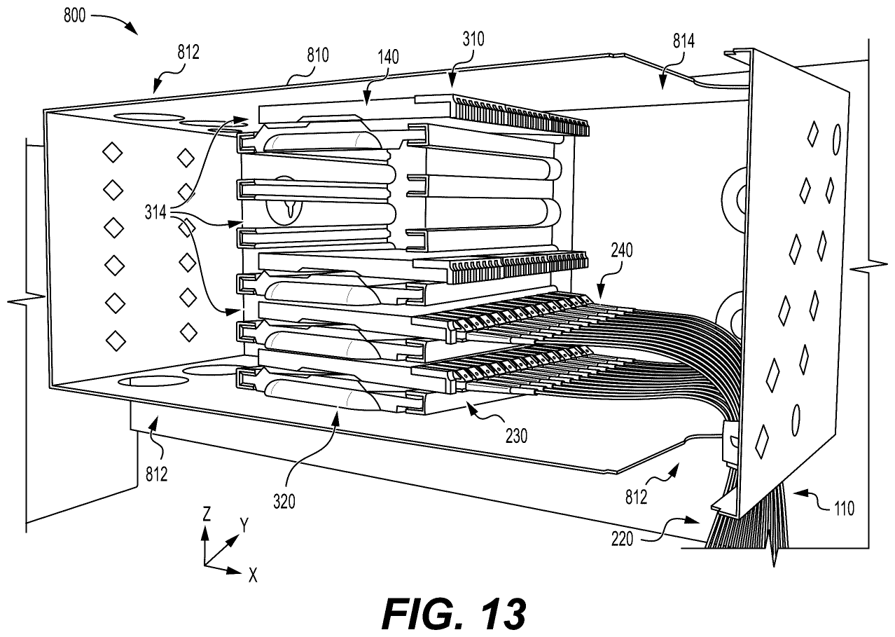

FIG. 13 displays a perspective view of portions of a network system 800 that employs a network component mounting system 300 in accordance with various embodiments. As shown, a mounting rack 310 is wholly positioned within a housing portion 810 that provides a number of separate cabling apertures 812. It is noted that the housing 810 can be any size and shape to provide an interior cavity 814 to securely position the rack 310 to allow the respective trays 320 to be selectively moved into, and out of, the receiving portions 314 defined between a pair of holding portions 312.

The position of the mounting system 300 within the housing portion 810 can facilitate efficient cooling along with cable 110/220 management. One embodiment utilizes cabling apertures 812 on a single side of the mounting system 300 to position both input cables 110 and output cables 220. Other embodiments utilize cabling apertures 812 on opposite sides of the mounting system 300 to organize cables 110/220, such as by network component or by input/output cables. The ability to utilize the assorted cabling apertures of the housing portion 810 allows a variety of cabling organization and management configurations, which can aid access to the assorted network components as well as cooling airflow through the rack 310.

The modular capabilities of the mounting system 300 can allow holding portions 312, and the corresponding receiving portions 314, to be added or removed from within the housing portion 810 at will. Such modularity further allows rails to be installed that are not occupied by a tray 320, as illustrated in FIG. 8. That is, one or more receiving portions 314 may be present, but unoccupied by trays 320, to provide space between network components, which can promote greater access, cable management, and cooling than if every receiving portion 314 was occupied by a tray 320 and corresponding network component.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A mounting arrangement structurally configured to provide enhanced mounting of a fiber optic cassette comprising
a tray portion configured to couple with a fiber optic cassette;
a rack portion structurally configured to receive the tray portion;
wherein the rack portion includes a first rack portion and a second rack portion, and wherein the first rack portion is identical to the second rack portion;
wherein the rack portion includes a holding portion structurally configured to hold the tray portion;
wherein the holding portion includes a receiving portion structurally configured to slidingly receive the tray portion;
wherein the holding portion includes a first holding portion and a second holding portion that are spaced apart from one another;
wherein the first rack portion includes the first holding portion, and the second rack portion includes the second holding portion;
wherein the receiving portion includes a first receiving portion and a second receiving portion;
wherein the first holding portion includes the first receiving portion, and the second holding portion includes the second receiving portion;
wherein the holding portion includes a locking portion configured to fix the tray portion at a predetermined position relative to the holding portion;
wherein the locking portion includes a first locking portion and a second locking portion;
wherein the first holding portion includes the first locking portion, and the second holding portion includes the second locking portion;
wherein the tray portion includes a surface portion that includes an attachment portion structurally configured to couple with a fiber optic cassette such that a fiber optic port portion of the fiber optic cassette faces in a direction of a side surface portion of the tray portion that is perpendicular to the surface portion; and
wherein the holding portion is configured to alternatively receive the tray portion in a first orientation wherein the side surface portion of the tray portion faces in a direction of the first holding portion and in a second orientation wherein the side surface portion of the tray portion faces in a direction of the second holding portion so as to enhance mounting of a fiber optic cassette.

2. The mounting system of claim 1, wherein the attachment portion is configured to face in a first direction that is perpendicular to the side surface portion of the tray portion in the first orientation and the second orientation;
wherein the holding portion is configured to alternatively receive the tray portion in a third orientation wherein the side surface portion of the tray portion faces in a direction of the first holding portion, and the attachment portion faces in a second direction opposite to the first direction; and
wherein the holding portion is configured to alternatively receive the tray portion in a fourth orientation wherein the side surface portion of the tray portion faces in a direction of the second holding portion, and the attachment portion faces in a second direction opposite to the first direction.

3. The mounting system of claim 1, wherein the locking portion includes an engagement portion; and
wherein the tray portion includes a retaining portion structurally configured to receive the engagement portion so as to fix the tray portion at the predetermined position relative to the holding portion.

4. The mounting system of claim 3, wherein the engagement portion is structurally configured to be biased to a first configuration so as to be received in the retaining portion and fix the tray portion at the predetermined position relative to the holding portion.

5. The mounting system of claim 4, wherein the engagement portion is structurally configured to be urged out of the retaining portion by the tray portion in response to a pulling force applied to the tray portion so as to release the tray portion from the predetermined position relative to the holding portion and permit the tray portion to slide relative to the holding portion.

6. The mounting system of claim 1, wherein the holding portion comprises a plurality of holding portions, and the tray portion comprises a plurality of tray portions; and
wherein the plurality of holding portions are arranged so as to receive the plurality of tray portions in a stacked configuration.

7. A mounting arrangement structurally configured to provide enhanced mounting of a fiber optic cassette comprising
a tray portion configured to couple with a fiber optic cassette;
a rack portion structurally configured to receive the tray portion;
wherein the rack portion includes a holding portion structurally configured to hold the tray portion;
wherein the holding portion includes a first holding portion and a second holding portion that are spaced apart from one another;
wherein the holding portion includes a receiving portion structurally configured to slidingly receive the tray portion;
wherein the holding portion includes a locking portion configured to fix the tray portion at a predetermined position relative to the holding portion;
wherein the tray portion includes a surface portion that includes an attachment portion structurally configured to couple with a fiber optic cassette such that a fiber optic port portion of the fiber optic cassette faces in a direction of a side surface portion of the tray portion that is perpendicular to the surface portion; and
wherein the holding portion is configured to alternatively receive the tray portion in a first orientation wherein the side surface portion of the tray portion faces in a direction of the first holding portion and in a second orientation wherein the side surface portion of the tray portion faces in a direction of the second holding portion so as to enhance mounting of a fiber optic cassette.

8. The mounting system of claim 7, wherein the attachment portion is configured to face in a first direction that is perpendicular to the side surface portion of the tray portion in the first orientation and the second orientation;
wherein the holding portion is configured to alternatively receive the tray portion in a third orientation wherein the side surface portion of the tray portion faces in a direction of the first holding portion, and the attachment portion faces in a second direction opposite to the first direction; and
wherein the holding portion is configured to alternatively receive the tray portion in a fourth orientation wherein the side surface portion of the tray portion faces in a direction of the second holding portion, and the attachment portion faces in a second direction opposite to the first direction.

9. The mounting system of claim 7, wherein the locking portion includes an engagement portion; and
wherein the tray portion includes a retaining portion structurally configured to receive the engagement portion so as to fix the tray portion at the predetermined position relative to the holding portion.

10. The mounting system of claim 9, wherein the engagement portion is structurally configured to be biased to a first configuration so as to be received in the retaining portion and fix the tray portion at the predetermined position relative to the holding portion.

11. The mounting system of claim 10, wherein the engagement portion is structurally configured to be urged out of the retaining portion by the tray portion in response to a pulling force applied to the tray portion so as to release the tray portion from the predetermined position relative to the holding portion and permit the tray portion to slide relative to the holding portion.

12. The mounting system of claim 7, wherein the holding portion comprises a plurality of holding portions, and the tray portion comprises a plurality of tray portions; and
wherein the plurality of holding portions are arranged so as to receive the plurality of tray portions in a stacked configuration.

13. The mounting system of claim 7, wherein the rack portion includes a first rack portion and a second rack portion; and
wherein the first rack portion includes the first holding portion, and the second rack portion includes the second holding portion.

14. The mounting system of claim 13, wherein the first rack portion is identical to the second rack portion.

15. The mounting system of claim 7, wherein the receiving portion includes a first receiving portion and a second receiving portion; and
wherein the first holding portion includes the first receiving portion, and the second holding portion includes the second receiving portion.

16. The mounting system of claim 7, wherein the locking portion includes a first locking portion and a second locking portion; and
wherein the first holding portion includes the first locking portion, and the second holding portion includes the second locking portion.

17. A mounting arrangement structurally configured to provide enhanced mounting of a fiber optic cassette comprising
a tray portion configured to couple with a fiber optic cassette;
a rack portion structurally configured to receive the tray portion;
wherein the rack portion includes a holding portion structurally configured to hold the tray portion;
wherein the holding portion includes a receiving portion structurally configured to slidingly receive the tray portion;
wherein the holding portion includes a locking portion configured to fix the tray portion at a predetermined position relative to the holding portion;
wherein the tray portion includes a surface portion that includes an attachment portion structurally configured to couple with a fiber optic cassette such that a fiber optic port portion of the fiber optic cassette faces in a direction of a side surface portion of the tray portion that is perpendicular to the surface portion; and
wherein the holding portion is configured to alternatively receive the tray portion in a first orientation wherein the side surface portion of the tray portion faces in a first direction toward the holding portion and in a second orientation wherein the side surface portion of the tray portion faces in a second direction, opposite to the first direction, toward the holding portion so as to enhance mounting of a fiber optic cassette.

18. The mounting system of claim 17, wherein the attachment portion is configured to face in a third direction that is perpendicular to the side surface portion of the tray portion in the first orientation and the second orientation;
wherein the holding portion is configured to alternatively receive the tray portion in a third orientation wherein the side surface portion of the tray portion faces in the first direction, and the attachment portion faces in a fourth direction opposite to the third direction; and
wherein the holding portion is configured to alternatively receive the tray portion in a fourth orientation wherein the side surface portion of the tray portion faces in the second direction, and the attachment portion faces in a fourth direction opposite to the first direction.

19. The mounting system of claim 17, wherein the locking portion includes an engagement portion; and
wherein the tray portion includes a retaining portion structurally configured to receive the engagement portion so as to fix the tray portion at the predetermined position relative to the holding portion.

20. The mounting system of claim 19, wherein the engagement portion is structurally configured to be biased to a first configuration so as to be received in the retaining portion and fix the tray portion at the predetermined position relative to the holding portion.

21. The mounting system of claim 20, wherein the engagement portion is structurally configured to be urged out of the retaining portion by the tray portion in response to a pulling force applied to the tray portion so as to release the tray portion from the predetermined position relative to the holding portion and permit the tray portion to slide relative to the holding portion.

22. The mounting system of claim 17, wherein the holding portion comprises a plurality of holding portions, and the tray portion comprises a plurality of tray portions; and
wherein the plurality of holding portions are arranged so as to receive the plurality of tray portions in a stacked configuration.

23. The mounting system of claim 17, wherein the holding portion includes a first holding portion and a second holding portion that are spaced apart from one another.

24. The mounting system of claim 23, wherein the holding portion is configured to alternatively receive the tray portion in the first orientation wherein the side surface portion of the tray portion faces in a direction of the first holding portion and in the second orientation wherein the side surface portion of the tray portion faces in a direction of the second holding portion so as to enhance mounting of a fiber optic cassette.

25. The mounting system of claim 23, wherein the rack portion includes a first rack portion and a second rack portion; and
wherein the first rack portion includes the first holding portion, and the second rack portion includes the second holding portion.

26. The mounting system of claim 25, wherein the first rack portion is identical to the second rack portion.

27. The mounting system of claim 23, wherein the receiving portion includes a first receiving portion and a second receiving portion; and
wherein the first holding portion includes the first receiving portion, and the second holding portion includes the second receiving portion.

28. The mounting system of claim 23, wherein the locking portion includes a first locking portion and a second locking portion; and
wherein the first holding portion includes the first locking portion, and the second holding portion includes the second locking portion.
